(19) United States
(12) Patent Application Publication
(10) Pub. No.: US 2009/0293228 A1
(43) Pub. Date: Dec. 3, 2009

(54) Door Hinge With Checker

(76) Inventor: Seiji Sasa, Saitama (JP)

Correspondence Address: ARENT FOX LLP, 1050 CONNECTICUT AVENUE, N.W., SUITE 400, WASHINGTON, DC, 20036, US

(21) Appl. No.: 11/922,576

(22) PCT Filed: Jun. 20, 2006
(86) PCT No.: PCT/JP2006/312288

§ 371 Date: Jun. 17, 2009

(30) Foreign Application Priority Data
Jun. 20, 2005 (JP) 2005-179365

(51) Int. Cl. E05F 1/08

(52) U.S. Cl. 16/297

(57) ABSTRACT

A door hinge with a checker is provided which has hinge members firmly fixed to a body and a door relatively rotatably coupled with hinge pins and the checker provided between the hinge members, wherein flexibility of a form of the hinge members is increased by rendering the checker placeable in a direction along axis lines of the hinge pins. A checker (19) includes: cam seats (28, 29) firmly fixed to a second hinge member (16) and including sliding contact surfaces (30, 31) along a plane orthogonal to the axis lines of hinge pins (17, 18) firmly fixed to a first hinge member (15) and locking concave portions (32, 33, 34); and engagement pins (35, 36) capable of sliding contact with the sliding contact surfaces (30, 31) and engagement with the locking concave portions (32, 33, 34) according to positioning of the first and second hinge members (15, 16) at predetermined relative rotation positions, and the engagement pins (35, 36) are spring-biased to the cam seats (28, 29) side while being coupled to the hinge pins (17, 18) in a state of being capable of displacement in the direction along the axis lines of the hinge pins (17, 18) and incapable of the relative rotation.

### TECHNICAL FIELD

The present invention relates to a door hinge with a checker, wherein a first hinge member firmly fixed to one of a body and a door and a second hinge member firmly fixed to the other of the body and door are coupled with hinge pins to be capable of relative rotation, and a checker for providing the relative rotation of the first and second hinge members with moderate resistance is provided between the first and second hinge members.

### BACKGROUND ART

Such a door hinge with a checker is already known as disclosed by Patent Publication 1 and Patent Publication 2, for example. Patent Publication 1: U.S. Pat. No. 6,739,020 Patent Publication 2: German Patent Application Laid-open No. 10254032

### DISCLOSURE OF THE INVENTION

### Problems to be Solved by the Invention

As for the door hinge with a checker disclosed by Patent Publication 1 and Patent Publication 2, however, the checker is arranged to be extended along a radial direction of hinge pins and housed in a housing hole provided to one of hinge members firmly fixed to each of the body and door. Therefore, space for placing the checker must be secured on one of the hinge members in a direction along the radial direction of the hinge pin so that flexibility of a form of the hinge members is reduced.

The present invention has been achieved in view of the above-mentioned circumstances, and has an object to provide a door hinge with a checker of which flexibility of a form of hinge members is increased by allowing the checker to be placed in a direction along axis lines of hinge pins.

### Means for Solving the Problem

To achieve the above object, according to a first aspect of the present invention, there is provided a door hinge with a checker having a first hinge member firmly fixed to one of a body and a door and a second hinge member firmly fixed to the other of the body and door relatively rotatably coupled with hinge pins, and providing with a checker for providing the relative rotation of the first and second hinge members with moderate resistance between the first and second hinge members, characterized in that the checker includes: cam seats firmly fixed to the second hinge member and including ring-shaped sliding contact surfaces along a plane orthogonal to axis lines of the hinge pins firmly fixed to the first hinge member and locking concave portions formed along a radial direction of the hinge pins and dented on the sliding contact surfaces; and engagement pins capable of sliding contact with the sliding contact surfaces and engagement with the locking concave portions according to positioning of the first and second hinge members at predetermined relative rotation positions, and the engagement pins are spring-biased to the cam seats side while being coupled to the hinge pins in a state of being capable of displacement in the direction along the axis lines of the hinge pins and incapable of the relative rotation.

According to a second aspect of the present invention, in addition to the first aspect, the first hinge member has a pair of hinge pins mutually opposed with spacing in the axial direction firmly fixed thereto, and the checker includes: the pair of cam seats relatively rotatably penetrated by the hinge pins respectively and having the locking concave portions with the sliding contact surfaces and the hinge pins at the positions along a circumferential direction mutually displaced on mutually opposed end faces respectively; the pair of engagement pins held by the hinge pins respectively; and a spring having a spring force for biasing the engagement pins toward the cam seats side and provided between the engagement pins.

According to a third aspect of the present invention, in addition to the second aspect, the second hinge member has a housing hole concentric with the hinge pins provided thereon; and the checker is housed in the housing hole so as to have the cam seats fixed at opposite ends of the housing hole.

### EFFECT OF THE INVENTION

With the arrangement of the first aspect, if the first and second hinge members relatively rotate around the axis line of a hinge axis, the checker has the relative rotation arising between the hinge pin firmly fixed to the first hinge member and the cam seat firmly fixed to the second hinge member. And the engagement pin coupled to the hinge pin to be capable of displacement in the axial direction of the hinge pin is resiliently fitted into the locking concave portion at a predetermined relative rotation position of the first and second hinge members so as to provide the relative rotation of the hinge members with moderate resistance. Furthermore, it is possible to increase flexibility of the form of the hinge members so as to place the checker in the direction along the axis line of the hinge pin.

With the arrangement of the second aspect, the checker includes a pair of cam seats penetrated by a pair of hinge pins capable of relative rotation respectively and having locking concave portions respectively, and a pair of engagement pins held by the hinge pins respectively. The engagement pins are selectively and resiliently fitted into the locking concave portions of the cam seats so as to provide the relative rotation of the hinge members with moderate resistance at a plurality of relative rotation positions. The locking concave portions of the cam seats are placed at the positions where the positions of the hinge pins along a circumferential direction are mutually displaced. Therefore, it is possible to place the locking concave portions without difficulties so as to provide the moderate resistance even at the positions where the relative rotation positions of the hinge members are slightly displaced.

With the arrangement of the third aspect, the checker is housed in the housing hole. Therefore, even if coating is performed to a vehicle in a state of being provided with the door hinge with the checker, the coating material does not influence actuation of the checker.

### BRIEF DESCRIPTION OF THE DRAWINGS

FIG. 1 is a plan view of an automobile provided with a door hinge with a checker. (first embodiment)

FIG. 2 is an enlarged view of an arrow portion 2 of FIG. 1 in a state of having a door completely closed. (first embodiment)

FIG. 3 is a sectional view of a line 3 to 3 of FIG. 2. (first embodiment)

FIG. 4 is a sectional view of a line 4 to 4 of FIG. 3. (first embodiment)

FIG. 5 is an exploded perspective view of the door hinge with a checker. (first embodiment)

FIG. 6 is a view of an arrow portion 6 of FIG. 3 in the state of having the door completely closed. (first embodiment)

FIG. 7 is a sectional view of a line 7 to 7 of FIG. 3 in the state of having the door completely closed. (first embodiment)

FIG. 8 is a sectional view of a line 8 to 8 of FIG. 3 in the state of having the door completely closed. (first embodiment)

FIG. 9 is a sectional view corresponding to FIG. 7 when having the door opened at a first opening angle. (first embodiment)

FIG. 10 is a sectional view corresponding to FIG. 8 when having the door opened at the first opening angle. (first embodiment)

FIG. 11 is a sectional view corresponding to FIG. 7 when having the door opened at a second opening angle. (first embodiment)

FIG. 12 is a sectional view corresponding to FIG. 8 when having the door opened at the second opening angle. (first embodiment)

FIG. 13 is a sectional view corresponding to FIG. 7 when having the door completely opened. (first embodiment)

FIG. 14 is a sectional view corresponding to FIG. 8 when having the door completely opened. (first embodiment)

### EXPLANATION OF REFERENCE NUMERALS AND SYMBOLS

15 First hinge member
16 Second hinge member
17, 18 Hinge pins
19 Checker
27 Housing hole
28, 29 Cam seats
30, 31 Sliding contact surfaces
32, 33, 34 Locking concave portions
35, 36 Engagement pins
37 Spring
B Body
D Door
H Door hinge with a checker

### BEST MODE FOR CARRYING OUT THE INVENTION

The mode for carrying out the present invention will now be described by way of one embodiment with reference to the accompanying drawings.

### Embodiment 1

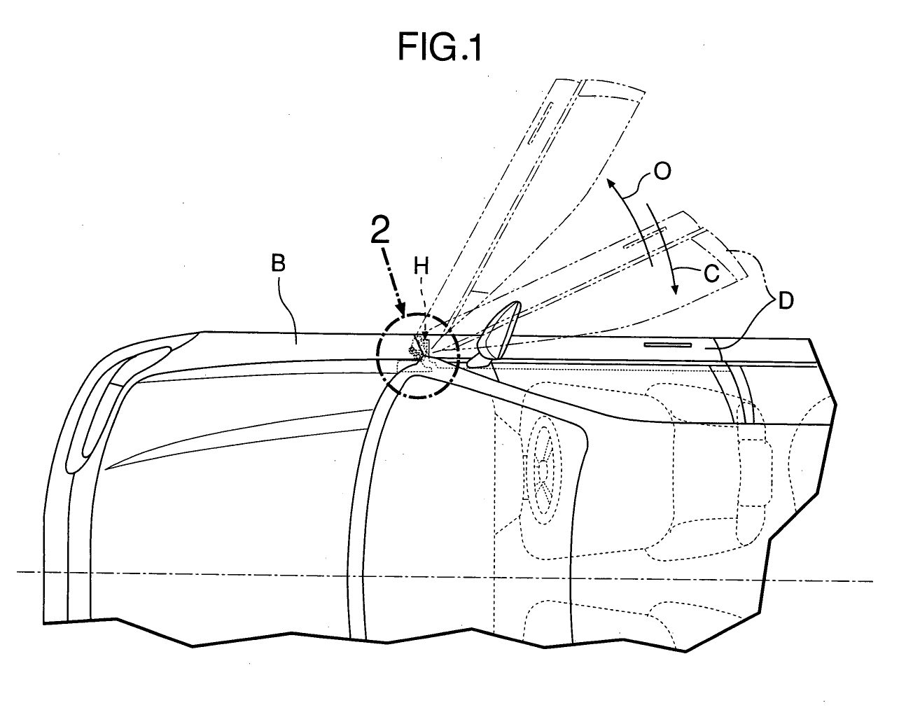

First, in FIG. 1, a body B of an automobile has a door D mounted thereon via a door hinge H with a checker of the present invention, where the door D can rotate in an opening direction indicated by an arrow O and in a closing direction indicated by an arrow C to open and close an entrance thereof.

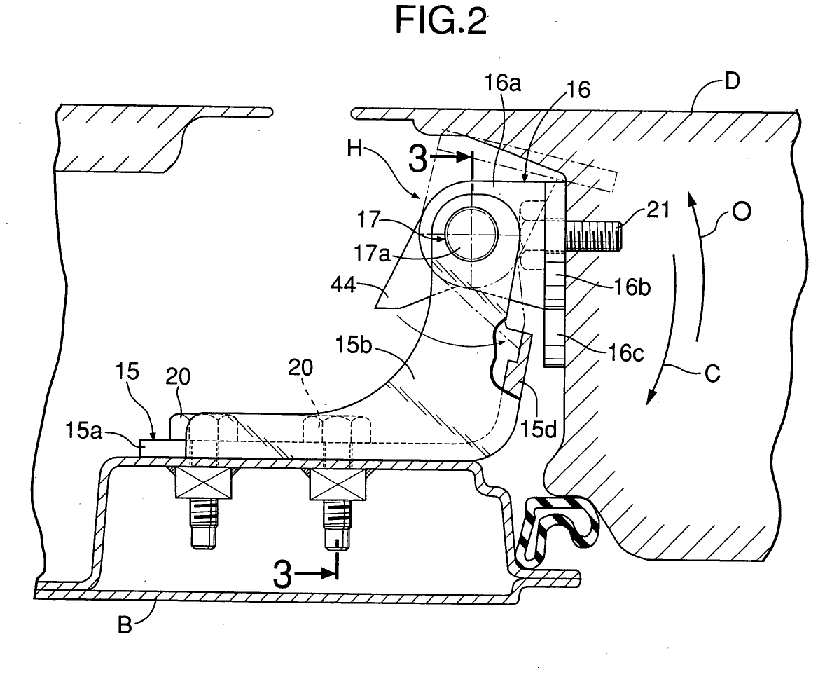

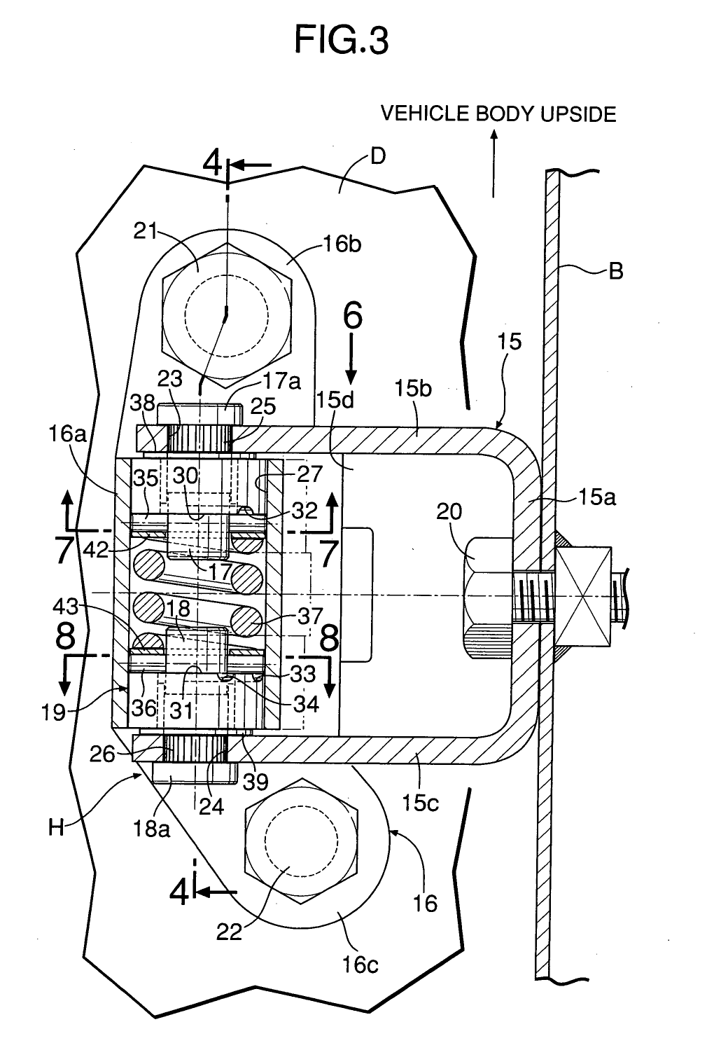

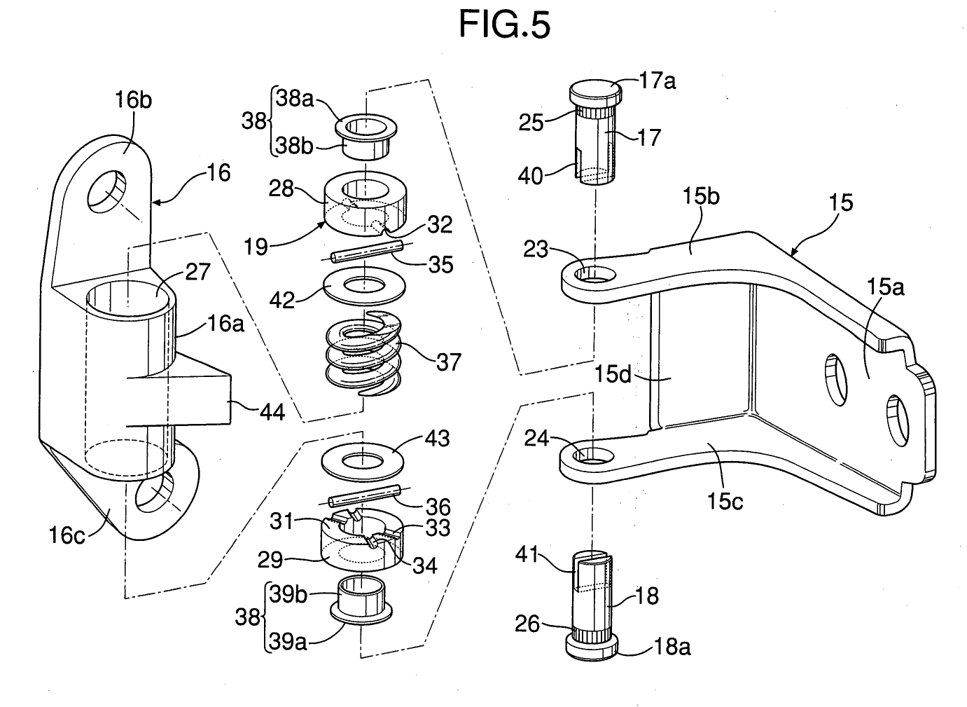

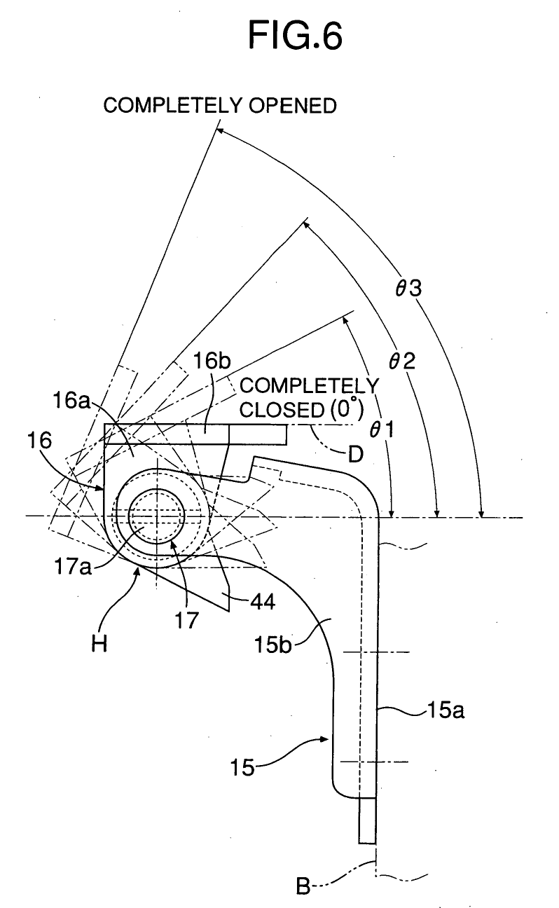

With reference to FIGS. 2 to 6 together, the door hinge H with a checker is formed of a first hinge member 15 firmly fixed to the body B as one of the door D and body B, a second hinge member 16 firmly fixed to the door D as the other of the door D and body B, a pair of hinge pins 17 and 18 for coupling the first and second hinge members 15 and 16 to be capable of relative rotation, and a checker 19 for providing the relative rotation of the first and second hinge members 15 and 16 with moderate resistance.

The first hinge member 15 is formed of a base plate portion 15a, a pair of support plate portions 15b and 15c erected on opposite sides of the base plate portion 15a and mutually opposed, and a coupling plate portion 15d connected to the base plate portion 15a by integrally coupling base end portions of the support plate portions 15b and 15c. The base plate portion 15a is fixed on the body B by a pair of bolts 20 and 20 in a state of having the support plate portions 15b and 15c placed at vertically separated positions.

The second hinge member 16 consists of: a block portion 16a placed between the support plate portions 15b and 15c of the first hinge member 15 and in contact with the door D; and a pair of base plate portion 16b and 16c overhanging vertically from the block portion 16a. The base plate portions 16b and 16c are fixed on the door D by bolts 21 and 22 respectively.

Pin holes 23 and 24 are concentrically provided at the ends of the support plate portions 15b and 15c of the first hinge member 15 respectively. The pair of hinge pins 17 and 18 are pressed into the pin holes 23 and 24 with one ends of the hinge pins 17 and 18 facing each other to be fixed on the first hinge member 15. To be more specific, the hinge pins 17 and 18 have massive portions 17a and 18a in contact with and engaged with lateral surfaces of the support plate portions 15b and 15c integrally with the other ends. In the portions corresponding to the pin holes 23 and 24 and on outer circumferences of the hinge pins 17 and 18, a plurality of grooves 25, 26 extending axially are provided by a knurling process. And the hinge pins 17 and 18 are pressed into the pin holes 23 and 24 respectively to have the massive portions 17a and 18a in contact with and engaged with the lateral surfaces of the support plate portions 15b and 15c.

The block portion 16a of the second hinge member 16 has a housing hole 27 concentric with the pin holes 23 and 24 provided thereon. And one ends of the pair of hinge pins 17 and 18 fixed on the support plate portions 15b and 15c of the first hinge member 15 are inserted concentrically into the housing hole 27.

The checker 19 includes: cam seats 28 and 29 firmly fixed to the second hinge member 16 and including ring-shaped sliding contact surfaces 30 and 31 along a plane orthogonal to axis lines of the hinge pins 17 and 18 firmly fixed to the first hinge member 15 and locking concave portions 32; 33, 34 formed along a radial direction of the hinge pins 17 and 18 and dented on the sliding contact surfaces 30 and 31; and engagement pins 35 and 36 capable of sliding contact with the sliding contact surfaces 30 and 31 and engagement with the locking concave portions 32, 33 and 34 according to positioning of the first and second hinge members 15 and 16 at predetermined relative rotation positions. The engagement pins 35 and 36 are spring-biased to the cam seats 28 and 29 side while being coupled to the hinge pins 17 and 18 in a state of being capable of displacement in the direction along the axis lines of the hinge pins 17 and 18 and incapable of the relative rotation.

Furthermore, according to this embodiment, the checker 19 includes: a pair of cam seats 28 and 29 penetrated by a pair of hinge pins 17 and 18 to be capable of relative rotation respectively and having the locking concave portions 32, 33 and 34 with the sliding contact surfaces 30 and 31 and the hinge pins 17 and 18 at the positions along a circumferential direction mutually displaced on mutually opposed end faces; a pair of engagement pins 35 and 36 held by the hinge pins 17 and 18 respectively; and a spring 37 having a spring force for biasing the engagement pins 35 and 36 toward the cam seats 28 and 29 side and provided between the engagement pins 35 and 36. The checker 19 is housed in the housing hole 27 so as to have the cam seats 28 and 29 fixed at opposite ends of the housing hole 27.

The pair of cam seats 28 and 29 are cylindrically formed, and are pressed into and fixed at opposite ends of the housing hole 27. Bushes 38 and 39 are mounted between the hinge pins 17 and 18 and between the cam seats 28 and 29 respectively. The bushes 38 and 39 are formed of: ring portions 38a and 39a sandwiched between the massive portions 17a and 18a of the hinge pins 17 and 18 and the cam seats 28 and 29; and cylindrical portions 38b and 39b integrally connected to the ring portions 38a and 39a so as to be mounted between the outer circumferences of the hinge pins 17 and 18 and inner circumferences of the cam seats 28 and 29.

At one ends of the hinge pins 17 and 18 projecting inward from the cam seats 28 and 29 in the housing hole 27, retention grooves 40 and 41 along one of the diameters of the hinge pins 17 and 18 are provided to open at one ends of the hinge pins 17 and 18 and on the outer circumferences of the hinge pins 17 and 18 respectively. The engagement pins 35 and 36 having the axis lines along one of the diameters of the hinge pins 17 and 18 are held by the retention grooves 40 and 41 so as to render opposite ends projected from the outer circumferences of the hinge pins 17 and 18 opposed to an inner surface of the housing hole 27. To be more specific, the engagement pins 35 and 36 are held by the hinge pins 17 and 18 respectively in the state capable of displacement in the direction along the axis lines of the hinge pins 17 and 18 and incapable of the relative rotation around the axis lines of the hinge pins 17 and 18. Furthermore, the retention grooves 40 and 41 are provided to the hinge pins 17 and 18 having the same position along the circumferential direction of the hinge pins 17 and 18, and the engagement pins 35 and 36 are held by the hinge pins 17 and 18 having the same position along the circumferential direction of the hinge pins 17 and 18 respectively.

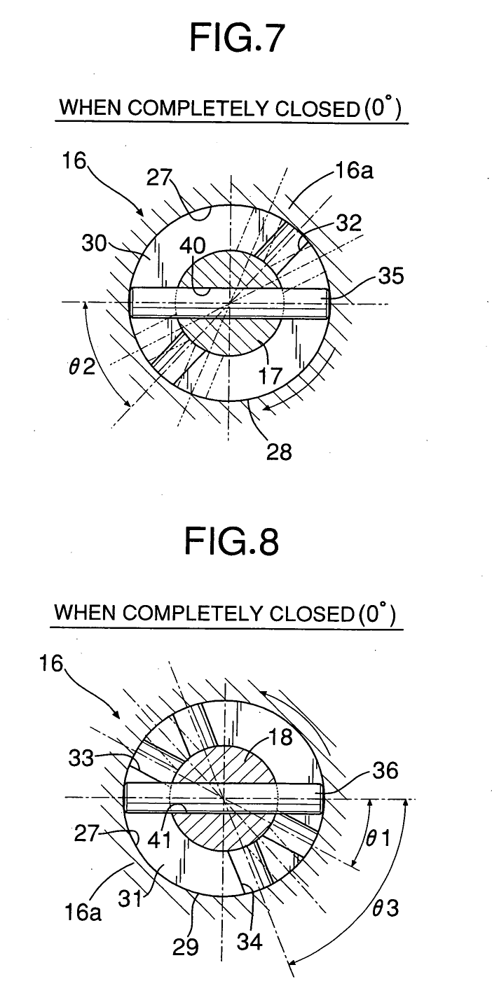

The checker 19 has a configuration in which, on rotating the door D in an opening direction O from its completely closed position, it provides moderate resistance at each opening angle, i.e., a first opening angle θ1 such as 28 degrees, a second opening angle θ2 larger than the first opening angle θ1 such as 48 degrees, and an opening angle θ3 in a completely opened state such as 68 degrees. As shown in FIG. 7, the sliding contact surface 30 of the cam seat 28 has one locking concave portion 32 provided thereon, which is extended along the radial direction of the one hinge pin 17 by sandwiching the hinge pin 17. The locking concave portion 32 is placed at the position for engaging the engagement pin 35 when the cam seat 28 rotates by the angle θ2 in the opening direction from the completely closed position of the door D into the direction indicated by the arrow. As shown in FIG. 8, the sliding contact surface 31 of the other cam seat 29 has the two locking concave portions 33 and 34 provided thereon, which are extended along the radial direction of the other hinge pin 18 by sandwiching the hinge pin 18. The locking concave portion 33 as one of the locking concave portions 33 and 34 is placed at the position for engaging the engagement pin 36 when the cam seat 29 rotates just by the angle θ1 in the opening direction from the completely closed position of the door D into the direction indicated by the arrow. The other locking concave portion 34 is placed at the position for engaging the engagement pins 36 when the cam seat 29 rotates just by the angle θ3 in the opening direction from the completely closed position of the door D into the direction indicated by the arrow.

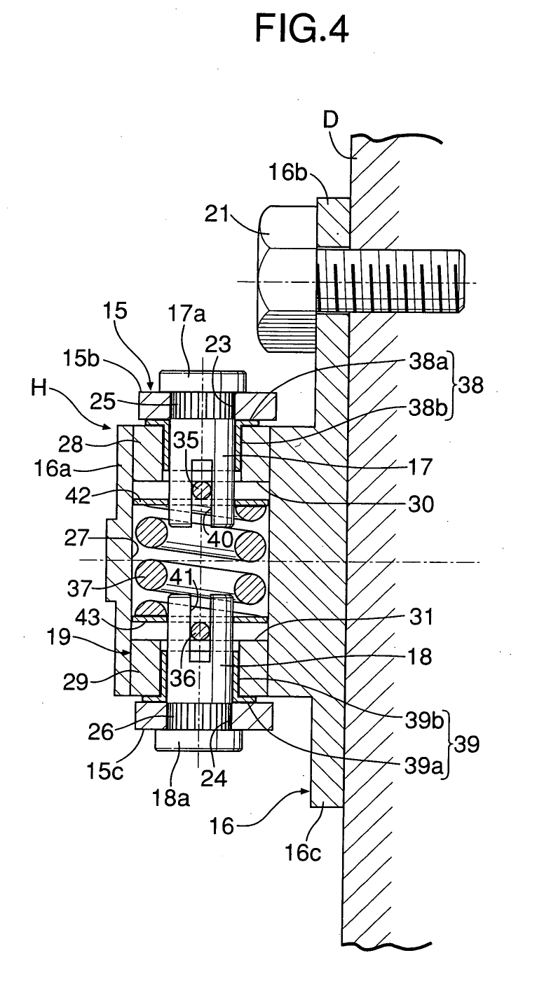

In FIG. 4 again, ring-shaped thrust washers 42 and 43 for inserting the hinge pins 17 and 18 are in contact with the engagement pins 35 and 36 from the opposite side to the cam seats 28 and 29, and the coiled spring 37 is contractedly mounted between the thrust washers 42 and 43.

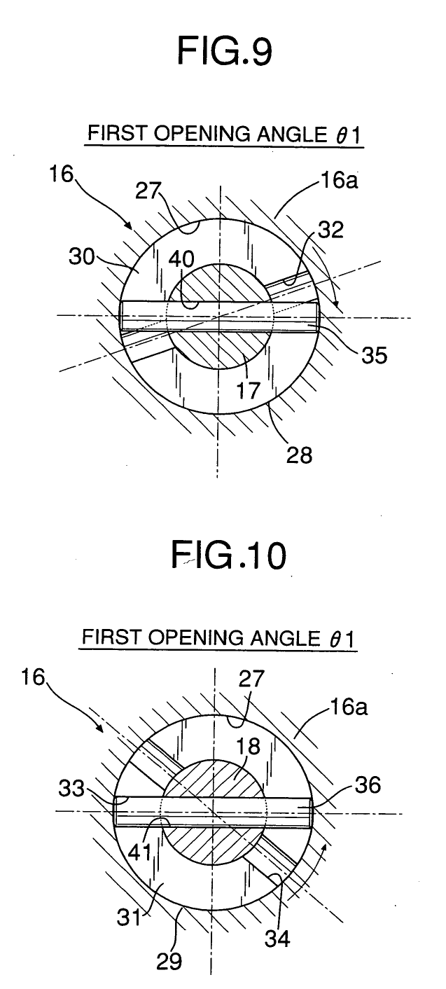

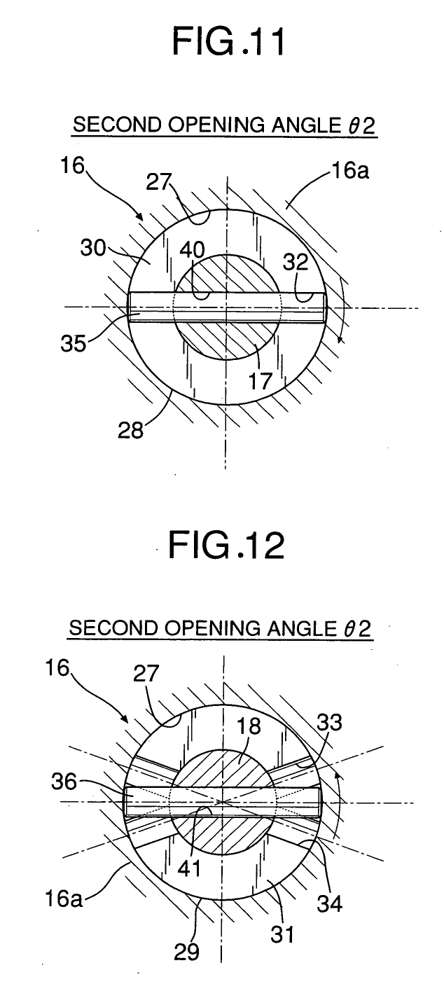

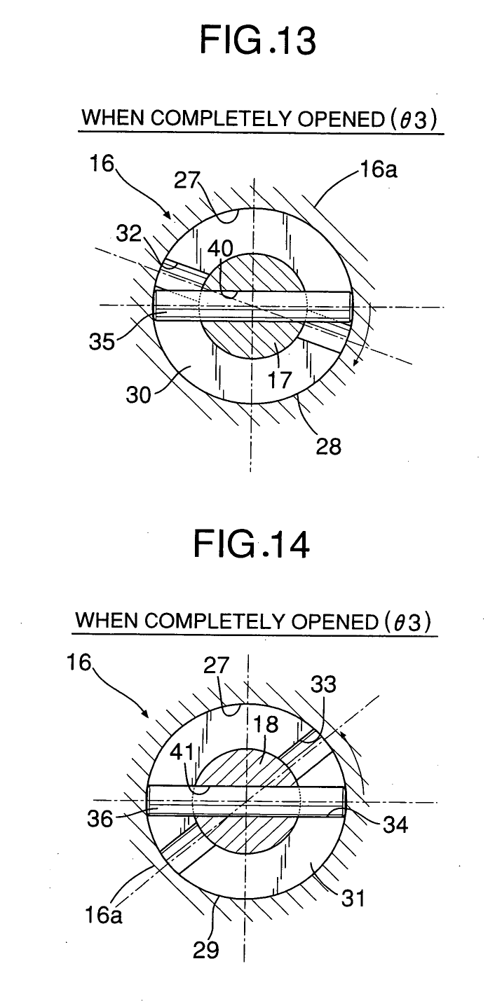

As for such a checker 19, the engagement pins 35 and 36 are in sliding contact with the sliding contact surfaces 30 and 31 of the cam seats 28 and 29 in the completely closed state of the door D as shown in FIGS. 7 and 8. As shown in FIGS. 9 and 10, when rotating the door D in the opening direction O from its completely closed position just by the opening angle θ1, the one engagement pin 35 is in sliding contact with the sliding contact surface 30 of the one cam seat 28 while the other engagement pin 36 is resiliently fitted into the locking concave portion 33 of the other cam seat 29. As shown in FIGS. 11 and 12, when rotating the door D in the opening direction O from its completely closed position just by the opening angle θ2, the one engagement pin 35 is resiliently fitted into the locking concave portion 32 of the one cam seat 28 while the other engagement pin 36 is in sliding contact with the sliding contact surface 31 between the locking concave portions 33 and 34 of the other cam seat 29. As shown in FIGS. 13 and 14, when further rotating the door D in the opening direction O from its completely closed position just by the opening angle θ3 to the completely opened position, the one engagement pin 35 is in sliding contact with the sliding contact surface 30 of the one cam seat 28 while the other engagement pin 36 is resiliently fitted into the locking concave portion 34 of the other cam seat 29.

To be more specific, the checker 19 provides the moderate resistance when the opening angle of the door D becomes θ1, θ2 and θ3 as the completely opened position on rotating the door D.

A stopper 44 is projected on the block portion 16a of the second hinge member 16 for the sake of regulating the rotation of the door D to the opening side by contacting the coupling plate portion 15d of the first hinge member 15 when the door D is further rotated in the opening direction O from the completely opened position.

Next, operation of this embodiment will be described. The checker 19 includes: cam seats 28 and 29 firmly fixed to the second hinge member 16 and including the ring-shaped sliding contact surfaces 30 and 31 along the plane orthogonal to the axis lines of the hinge pins 17 and 18 firmly fixed to the first hinge member 15 and locking concave portions 32; 33, 34 formed along the radial direction of the hinge pins 17 and 18 and dented on the sliding contact surfaces 30 and 31; and engagement pins 35 and 36 having the axis lines along one of the diameters of the hinge pins 17 and 18 and held by the hinge pins 17 and 18 in a state of being capable of displacement in the direction along the axis lines of the hinge pins 17 and 18 and incapable of the relative rotation while being spring-biased to the side contacting the sliding contact surfaces 30 and 31. Therefore, it is possible to increase flexibility of the form of the first and second hinge members 15 and 16 by placing the checker 19 in the direction along the axis lines of the hinge pins 17 and 18.

Furthermore, the first hinge member 15 has a pair of hinge pins 17 and 18 mutually opposed with spacing in the axial direction firmly fixed thereto. The checker 19 includes: a pair of cam seats 28 and 29 penetrated by the hinge pins 17 and 18 to be capable of relative rotation respectively and having the locking concave portions 32; 33, 34 with the sliding contact surfaces 30 and 31 and the hinge pins 17 and 18 at the positions along a circumferential direction mutually displaced on mutually opposed end faces respectively; a pair of engagement pins 35 and 36 held by the hinge pins 17 and 18 respectively; and a spring 37 having a spring force for biasing the engagement pins 35 and 36 toward the cam seats 28 and 29 side and provided between the engagement pins 35 and 36. The engagement pins 35 and 36 are selectively and resiliently fitted into the locking concave portions 32; 33, 34 of the cam seats 28 and 29 so as to provide the relative rotation of the hinge members 15 and 16 with moderate resistance at a plurality of relative rotation positions. The locking concave portions 32; 33, 34 of the cam seats 28 and 29 are placed at the positions where the positions of the hinge pins 17 and 18 along the circumferential direction are mutually displaced. Therefore, it is possible to place the locking concave portions 32; 33, 34 on the cam seats 28 and 29 without difficulties so as to provide the moderate resistance even at the positions where the relative rotation positions of the first and second hinge members 15 and 16 are slightly displaced.

Furthermore, the second hinge member 16 has a housing hole 27 concentric with the hinge pins 17 and 18 provided thereon. The checker 19 is housed in the housing hole 27 so as to have the cam seats 28 and 29 fixed at both ends of the housing hole 27. Therefore, even if coating is performed to a vehicle in a state of being provided with the door hinge H with a checker, the coating material does not influence actuation of the checker 19.

Although the embodiment of the present invention has been described in detail, it will be understood that the present invention is not limited to the above-described embodiment, and various modifications in design may be made without departing from the subject matter of the invention defined in the claims.

1. A door hinge with a checker having a first hinge member (15) firmly fixed to one of a body (B) and a door (D) and a second hinge member (16) firmly fixed to the other of the body (B) and door (D) relatively rotatably coupled with hinge pins (17, 18), and providing with a checker (19) for providing the relative rotation of the first and second hinge members (15, 16) with moderate resistance between the first and second hinge members (15, 16), characterized in that the checker (19) includes: cam seats (28, 29) firmly fixed to the second hinge member (16) and including ring-shaped sliding contact surfaces (30, 31) along a plane orthogonal to axis lines of the hinge pins (17, 18) firmly fixed to the first hinge member (15) and locking concave portions (32; 33, 34) formed along a radial direction of the hinge pins (17, 18) and dented on the sliding contact surfaces (30, 31); and engagement pins (35, 36) capable of sliding contact with the sliding contact surfaces (30, 31) and engagement with the locking concave portions (32; 33, 34) according to positioning of the first and second hinge members (15, 16) at predetermined relative rotation positions, and the engagement pins (35, 36) are spring-biased to the cam seats (28, 29) side while being coupled to the hinge pins (17, 18) in a state of being capable of displacement in the direction along the axis lines of the hinge pins (17, 18) and incapable of the relative rotation.

2. The door hinge with a checker according to claim 1, wherein the first hinge member (15) has a pair of hinge pins (17, 18) mutually opposed with spacing in the axial direction firmly fixed thereto, and the checker (19) includes: the pair of cam seats (28, 29) relatively rotatably penetrated by the hinge pins (17, 18) respectively and having the locking concave portions (32; 33, 34) with the sliding contact surfaces (30, 31) and the hinge pins (17, 18) at the positions along a circumferential direction mutually displaced on mutually opposed end faces respectively; the pair of engagement pins (35, 36) held by the hinge pins (17, 18) respectively; and a spring (37) having a spring force for biasing the engagement pins (35, 36) toward the cam seats (28, 29) side and provided between the engagement pins (35, 36).

3. The door hinge with a checker according to claim 2, wherein the second hinge member (16) has a housing hole (27) concentric with the hinge pins (17, 18) provided thereon; and the checker (19) is housed in the housing hole (27) so as to have the cam seats (28, 29) fixed at opposite ends of the housing hole (27).
